(19) United States
(12) Patent Application Publication
(10) Pub. No.: US 2005/0215229 A1
(43) Pub. Date: Sep. 29, 2005

(54) Call processing system

(76) Inventor: Steven D. Cheng, San Diego, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/811,187

(22) Filed: Mar. 26, 2004

(51) Int. Cl. H04M 3/00

(52) U.S. Cl. 455/404.1

(57) ABSTRACT

Call processing system and method for mobile users. The processing system identifies call urgency by categorizing incoming emergency data calls, and prioritizes the data calls accordingly. The emergency call processing method comprises submitting a data call to an emergency call center, placing the data call in a queuing system according to the priority level of the emergency, and waiting for an available processing unit to call back and address the emergency. During the waiting period, the emergency call center solicits information associated with the emergency, and user equipment returns the requested information automatically. The present invention improves efficiency of the emergency call center, ensuring that the most urgent emergency is served first. Additionally, the present invention conserves battery power of user equipment by collecting relevant information beforehand using data messages.

### BACKGROUND OF THE INVENTION

1. Field of the Invention

The present invention relates to a call processing system, and more specifically, to a call processing system for mobile users.

2. Description of the Related Art

Emergency call users can experience long waiting times before connecting to the operator, due to large volume, as much as several hours. Currently, emergency calls are handled by a one-phase emergency call model, wherein each caller employs a complete voice channel to the operator once the emergency call is connected. The operator maintains the communication with the caller until the emergency issue is resolved. Emergency calls are not guaranteed to be served in a First-in-first-out (FIFO) order if they are not placed in the queue successfully. If the caller uses a mobile phone to call the emergency call processing center, the long waiting time can consume battery energy and the battery may become exhausted before connection.

FIG. 1 is a diagram illustrating a basic queue model. Vₐᵣᵣᵢᵥₐₗ represents the arrival rate of requests (or calls), and V_{processing} the speed of the processing unit 14. When Vₐᵣᵣᵢᵥₐₗ exceeds V_{processing}, arrival requests are placed wait in a waiting buffer 12. As shown in FIG. 1, the waiting buffer 12 stores N queued arrival requests. Some arrival requests are rejected from admission to the waiting buffer 12 if there are more than N admission requests at the same time. The wait sequence is guaranteed only if the arrival request is admitted to the waiting buffer 12.

In current emergency call center design, the processing unit 14 is handled mainly by operators and the waiting buffer 12 is adopted using the traditional Telephone Private Branch telephone Exchanger (PBX) design. In some metropolitan areas, processing speed V_{processing} is estimated to around 1-3 minutes per call, although the arrival rate of emergency calls Vₐᵣᵣᵢᵥₐₗ is estimated from 100 to 1000. In order to handle such large volume, the emergency call center usually provides multiple operators as shown in FIG. 2 to speed processing. The example shown in FIG. 2 illustrates an emergency call center with three processing units (i.e. operators) 24a˜24c handling requests from a waiting buffer 22. Nonetheless, some emergency call requests still experience a long waiting period even with multiple processing units processing the call requests in parallel. This problem is aggravated for mobile users as the calls may not connect to a local emergency service, but rather to a regional center.

Apart from serious delays, callers may have difficulty passing all relevant information to the operator in an efficient manner when the call is finally connected. Mobile users suffering medical emergencies are likely to have difficulty reporting exact locations and conditions. There is therefore a need to improve the emergency call system, such that callers can provide accurate information successfully in any urgent situation.

### SUMMARY OF THE INVENTION

Accordingly, the object of the present invention is to improve efficiency of an emergency call center.

Another object of the present invention is to provide categorized prioritization of emergency calls, in order to ensure processing of the most urgent calls first.

Another object of the present invention is to provide an emergency call processing system particularly for mobile users, consuming a minimum battery power employing data communication measures between the emergency call center and mobile users.

In order to achieve these objects, the present invention provides an emergency call processing method and system for mobile users using data service. The emergency call processing system comprises user equipment (UE) registered in a wireless communication system and an emergency call center connected to the same wireless communication system. The UE submits an emergency data call to the emergency call enter in an emergency. The emergency call center returns a confirmation message including registration identification (ID) after receiving the emergency data call from the UE. The emergency data call enters a queuing system of the emergency call center, comprising a first waiting buffer, a sorter, prioritized waiting buffers, and at least one processing unit. The waiting buffers operate on a first-in-first-out (FIFO) basis, storing the emergency calls. The sorter receives the emergency calls from the first waiting buffer, categorizing and determining a priority of each emergency data call. The sorter then passes each emergency data call to one of the prioritized waiting buffers according to priority. Each processing unit serves the emergency data calls from the prioritized waiting buffers according to priority. The processing unit is operated by either operator or automatically. The processing unit replies to the corresponding caller to confirm the emergency and begins to resolve the problem.

The emergency data call originating with the UE comprises caller phone number, emergency message, location, and personal information. The message can utilizes voice, image, text, or combinations thereof.

The UE changes to automatic hand-shaking mode after receiving the confirmation message from the emergency call center, such that the UE is able to return the alert message from the emergency call center automatically. The alert message requests relevant information such as location, current conditions, or identifying location images. The UE returns the requested information with the registration ID assigned by the emergency to speed processing. The emergency call center uses an interleaving approach to periodically communicate with the UE, thus collecting relevant information beforehand. For more accurate positioning, the emergency call center updates the location information periodically. Data communication requesting and passing relevant information between the center and the UE can be implemented simply by a short message system (SMS) or other data services. The UE end uses client software for integration into the automatic hand-shaking process.

### BRIEF DESCRIPTION OF THE DRAWINGS

The present invention can be more fully understood by reading the subsequent detailed description in conjunction with the examples and references made to the accompanying drawings, wherein:

FIG. 1 illustrates a basic queuing model for incoming calls.

FIG. 2 illustrates a queuing model with three processing units to speed processing.

FIG. 3 illustrates a queuing model for the present invention.

FIG. 4a illustrates message flow between user equipment and an emergency call center of the two-phase emergency call model according to the first embodiment of the present invention.

FIG. 4b shows an example of the emergency data call composition.

FIG. 5a illustrates message flow between user equipment and an emergency call center of a multi-phase emergency call model according to the second embodiment of the present invention.

FIG. 5b shows another example of the emergency data call composition.

FIG. 5c shows an example of the confirmation message composition.

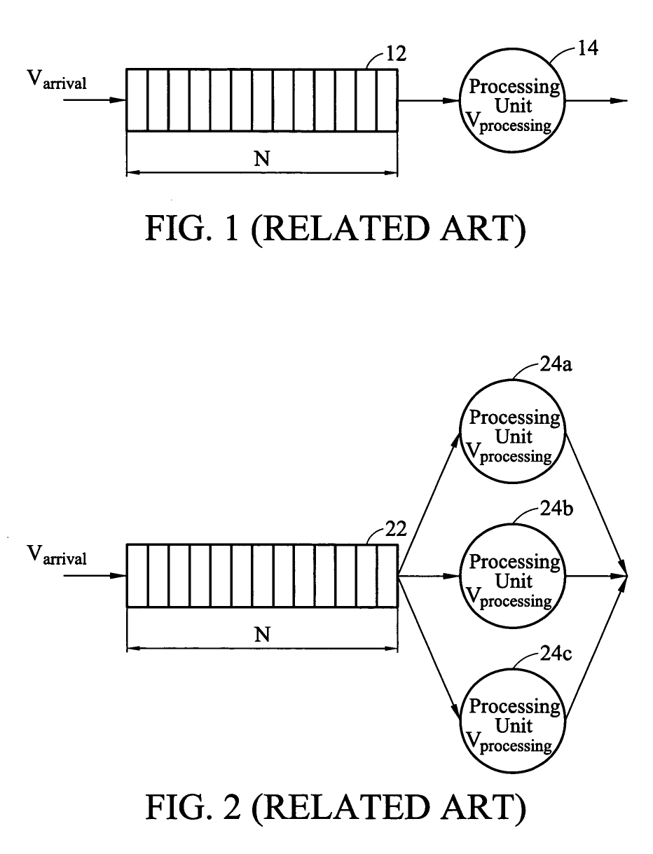

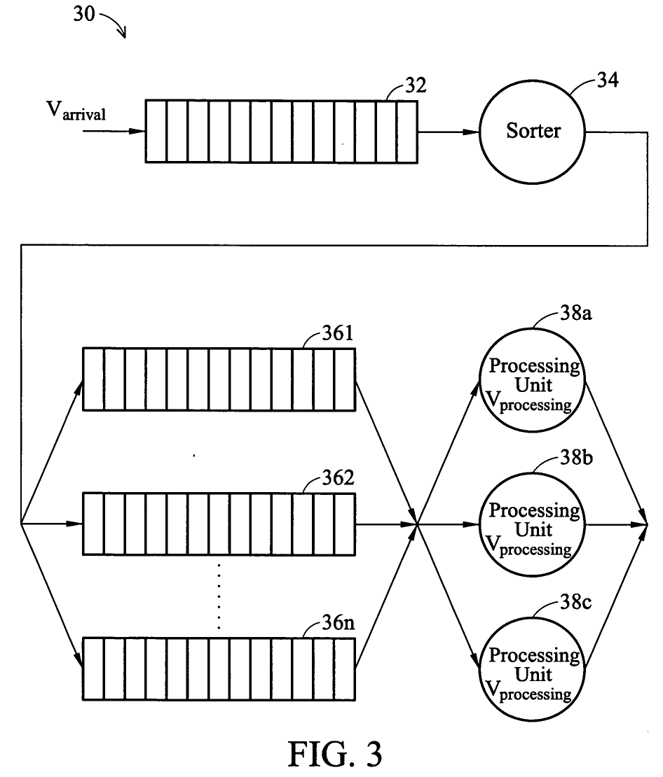

### DETAILED DESCRIPTION OF THE INVENTION

The present invention proposes a method and system thereof utilizing data service to improve efficiency of an emergency call processing system. In the present invention, data communication is employed with voice communication in the emergency call processing system rather than relying on voice only. By transmitting data through a data service such as short message service (SMS), long waiting problems are alleviated. Data service including crucial information can be filtered from the voice calls, and handled in a multi-phase emergency call model, explained later. Compared to the one-phase emergency call model implemented currently, the multi-phase emergency call model reduces major traffic and helps to alleviate the voice-based emergency call waiting issue.

In the conventional emergency call processing system, operators must verbally solicit information regarding callers' situation, and then dispatch appropriate emergency assistance. The inventive approach using automatic categorization of emergency requirements, provides operators with beforehand knowledge of conditions before calling back to confirm user needs. Since some emergency calls may be life threatening, while others less urgent, it is critical to prioritize calls appropriately.

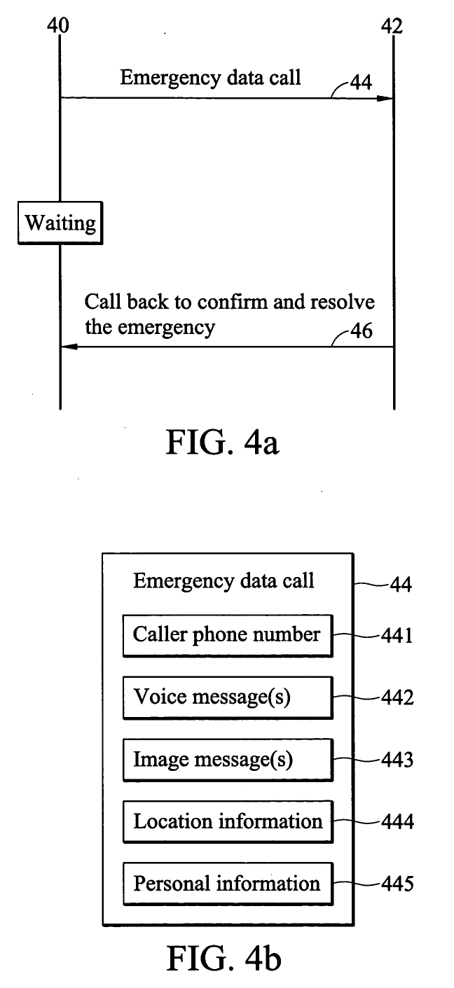

FIG. 3 illustrates an example of the queuing system 30 implemented in the present invention. The queuing system 30 provides categorized prioritization of emergency calls. As shown in FIG. 3, emergency calls are first stored in a waiting buffer 32 in a First-in-first-out (FIFO) manner, and a sorter 34 acquires the emergency calls therefrom. The sorter 34 is a computer-based processing unit capable of discrimination among various emergency call types. The sorter 34 assigns each emergency call to one of n prioritized waiting buffers 361˜36n. As shown in FIG. 3, each prioritized waiting buffer stores emergency calls with a dedicated priority level. Buffer 361 stored the highest priority emergency calls, 362 the second-highest, and buffer 36n the lowest priority emergency calls. While, for brevity, there are only three processing units 38a˜38c shown in this example, the number thereof is adjustable, and is to be determined based on the emergency call arrival rate (Vₐᵣᵣᵢᵥₐₗ) and the average processing speed (V_{processing}) of the system. Processing units 38a˜38c acquire emergency calls from the prioritized waiting buffers 361˜36n according to priority. The prioritized waiting buffers 361˜36n are FIFO buffers, and the highest priority calls stored in the buffer 361 will be served first. The processing units 38a˜38c can be operated by either operators or automatically. The inventive approach also assumes that all emergency center computer systems are connected and can access calls stored in the buffers. Thus, the emergency call processing system of the present invention improves the efficiency of operators (either human or machines) associated with each emergency center.

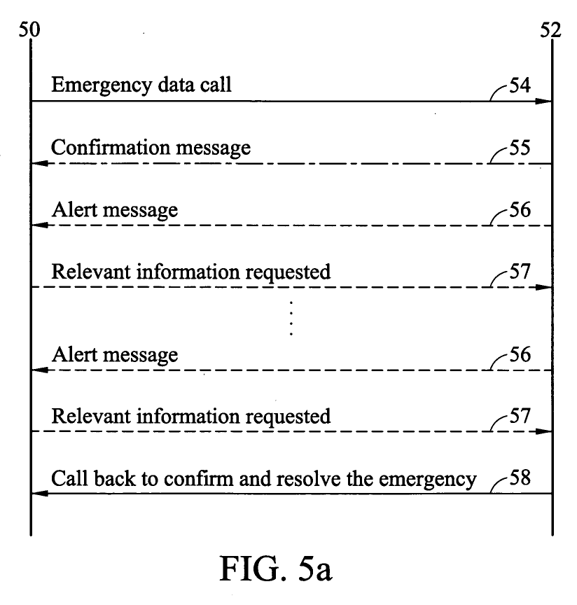

In the present invention, emergency calls are mobile-originating data calls transmitted through data networks rather than voice networks. FIG. 4a illustrates message flow between user equipment (UE) 40 and an emergency call center 42 of the two-phase emergency call model according to the first embodiment of the present invention. UE 40 passes all available information associated with the mobile user and the UE 40 to the emergency call center 42 by sending an emergency data call 44. The UE 40 can comprise a cellular phone, a personal digital assistant (PDA), or any other communication device. FIG. 4b shows an example of the emergency data call 44 composition. The information carried by the emergency data call 44 can include caller phone number 441, voice message 442, image message 443, location information 444, and personal information 445. The emergency data call 44 is sent in a special format providing most information the emergency operator is likely require before dispatch appropriate assistance. Once the emergency data call 44 is transformed from voice to data, it can easily be stored in a secondary memory such as hard disc or tape device, independent from waiting buffer overflow issues.

The UE 40 does not require holding the phone line to wait for the queuing process unlike conventional emergency call process. Rather, the UE 40 disconnects and waits for the emergency call center 42 to call back, and battery power is thus conserved. The emergency data call 44, after arrival at the emergency call center 42, enters a queuing system as previously described with FIG. 3. As mentioned, since each emergency data call may have a different level of urgency, emergency call center 42 assigns each data call a different priority and processes the highest priority first. The emergency data call 44 is eventually forwarded to a processing unit, which responds to the UE 40 to confirm and resolve the emergency 46. The emergency call center 42 acquires information associated with the emergency beforehand, thus reducing the time spent soliciting the relevant information. The two-phase emergency call model shown in FIG. 4a improves the overall response efficiency of the emergency call center 42.

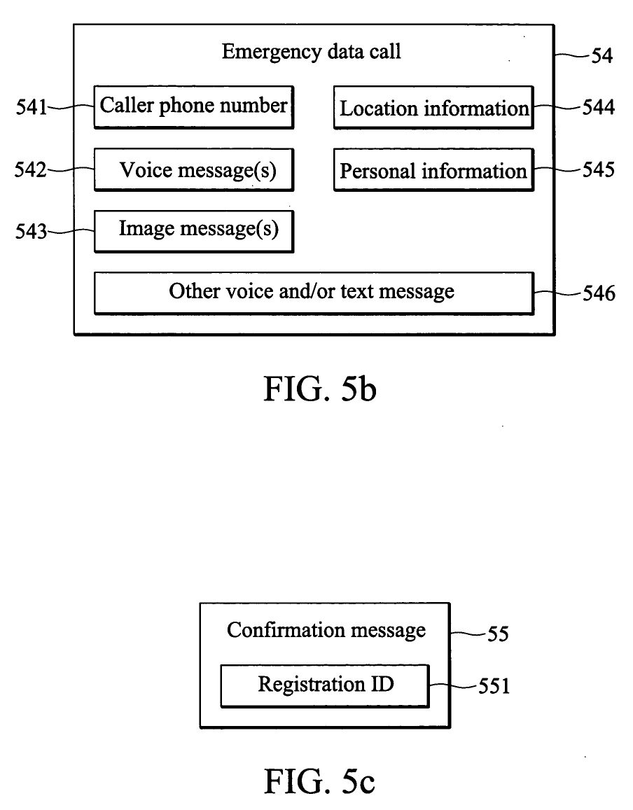

FIG. 5a illustrates message flow between UE 50 and an emergency call center 52 of a multi-phase emergency call model according to the second embodiment of the present invention. UE 50 sends an emergency data call 54 as the first message for registration. Once call 54 arrives, the emergency call center returns a confirmation message 55 with registration identification (ID) to the UE 50 to confirm that the emergency call is being processed. As shown in FIG. 5b, the emergency data call 54 may include caller phone number 541, voice message 542, image message 543, location information 544, personal information 545, and other voice and/or text elements 546. The emergency data call 54 is usually restricted to only a short message for registration, containing only caller phone number and a brief description of the emergency. The emergency call center 52 categorizes and prioritizes the arrival emergency data call 54 as in the first embodiment.

In the second embodiment, the emergency call center 52 sends a confirmation message 55 to UE 50 to acknowledge the arrival of the emergency data call 54, normally comprising registration identification (ID) 551 as shown in FIG. 5c. Upon receipt of confirmation message 55, the UE 50 changes to automatic hand-shaking mode. The emergency call center 52 then continues to collect relevant information from the UE 50 automatically, sending an alert message 56 to the UE 50. Examples of relevant information include current location, physical condition, current location audio/image data, and other information.

In conventional emergency call processing system, disorientation can present a common problem for callers, and it can take a long time for them to convey their precise location. The location of the mobile user can be obtained by a locating service provided in the communication system, for example, Global Positioning System (GPS). The emergency call center 52 requests current location information using the alert message 56, and the UE 50 responds with current location automatically.

Personal information can include personal identification, health history, medical history, or other related information previously stored in the UE 50. When the user triggers an emergency call, the above information passes to the emergency call center if the scenario is related to medical issues. The emergency call center can use the information to more efficiently assess the caller condition, speeding the rescue procedure.

The UE 50 may have a camera device associated with it, and, if so, the emergency caller can convey image based information regarding their surroundings. Incoming emergency data calls with image data can be analyzed, with resultant information passed to the operator. For example, a person bitten by a poisonous snake can submit an image of the snake to the emergency call center for identification, enabling emergency response personnel to provide remedy accordingly.

In the automatic hand-shaking status, the emergency call center 52 uses an interleaving approach to systematically communicate with the UE 50 by sending alert message 56 to request the relevant information 57. In order to implement the hand-shaking protocol efficiently, the UE 50 must have client software installed, and local emergency service implementation of the system further popularizes such installation as standard.

Emergency messages incorporating requested relevant information 57 carry a field for registration ID, so the emergency response system, based on recognition of this field, can bypass the waiting procedure.

Network protocols can distinguish between incoming voice and emergency data calls. Voice calls, generate existing PBX signals to the operator directly, otherwise, the PBX routes the recognized data call into the emergency call processing system described above. The multi-phase emergency call processing model disclosed here can co-operate with conventional emergency call processing models. Further, even when operating in data mode, the UE can still convert voice signal into data format and embed the information into emergency data call contents, as shown in FIGS. 4b and 5b.

Battery life of the UE is a key factor in maintaining the emergency call processing protocol of the present invention. In order to maintain enough battery power for later communication, the present invention provides a solution for further battery energy conservation, wherein the UE changes to a special power-saving mode when receiving confirmation from the emergency call center. In this mode, or special Discontinuous Receiving Mode (DRX), the UE will not activate until the DRX timeout, provided by the emergency call center automatically expires.

Finally, while the invention has been described by way of example and in terms of the above, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation so as to encompass all such modifications and similar arrangements.

1. An emergency call processing system for mobile users, comprising:
a receiver, receiving emergency data calls from the mobile users; and
a queuing system, prioritizing incoming emergency data calls, and subsequently responding to each of the mobile users to address the emergency according to the emergency data calls.

2. The emergency call processing system according to claim 1, the queuing system further comprising:
a first waiting buffer, storing incoming emergency data calls in a first-in-first-out (FIFO) manner;
a sorter, categorizing emergency data calls and prioritizing for each upon receipt from the first waiting buffer;
prioritized waiting buffers, receiving and storing emergency data calls from the sorter, wherein each prioritized waiting buffer is assigned to a different level of priority, and stores the emergency data calls with a corresponding level of priority; and
at least one processing unit, receiving and processing the emergency data calls from the prioritized waiting buffers according to their corresponding priority in a FIFO manner.

3. The emergency call processing system according to claim 2, wherein the processing unit is operated by either operator or automated system.

4. The emergency call processing system according to claim 1, wherein each of the emergency data calls carries caller phone number and a message reporting the emergency.

5. The emergency call processing system according to claim 4, wherein the message is selectively one of voice, image, text and combinations thereof.

6. The emergency call processing system according to claim 4, wherein each emergency data call further carries location information or personal information for the caller.

7. The emergency call processing system according to claim 1, wherein a confirmation message is sent to each mobile user upon receipt of a corresponding emergency data call.

8. The emergency call processing system according to claim 7, wherein the confirmation message comprises assigned registration identification.

9. The emergency call processing system according to claim 1, wherein mobile users submit emergency data call and replies to an emergency call center automatically using client software installed in user equipment.

10. The emergency call processing system according to claim 9, wherein the user equipment changes to automatic hand-shaking mode after receiving a confirmation message from the emergency call center.

11. The emergency call processing system according to claim 10, wherein the emergency call center solicits relevant information from mobile users in an alert message to the user equipment.

12. The emergency call processing system according to claim 11, wherein the alert message is sent via short message system (SMS).

13. The emergency call processing system according to claim 11, wherein the user equipment returns relevant information to the emergency call center automatically upon receipt of the alert message.

14. The emergency call processing system according to claim 13, wherein the user equipment also returns registration identification, provided beforehand by the emergency call center, with the relevant information.

15. The emergency call processing system according to claim 13, wherein the emergency call center utilizes an interleaving approach to periodically communicate with user equipment.

16. The emergency call processing system according to claim 11, wherein relevant information comprises location, caller's physical condition, current surrounding images, or combinations thereof.

17. An emergency call processing method for mobile users, comprising the steps of:
receiving an emergency data call from user equipment (UE); and
replying to the UE to confirm and address the emergency.

18. The emergency call processing method according to claim 17, further comprising prioritizing arrival emergency data calls.

19. The emergency call processing method according to claim 18, further comprising:
storing the incoming emergency data calls in a first waiting buffer;
categorizing the emergency data calls;
determining and assigning a priority level for each emergency data call output from the first waiting buffer;
assigning different priority levels to prioritized waiting buffers;
storing each emergency data call in one of the prioritized waiting buffers according to the assigned priority level, wherein each prioritized waiting buffer operates in a first-in-first-out manner;
processing emergency data calls stored in the prioritized waiting buffers according to the priority level assigned to the prioritized waiting buffer.

20. The emergency call processing method according to claim 17, wherein the emergency data call carries caller phone number and a message reporting the emergency.

21. The emergency call processing method according to claim 20, wherein the message is selectively one of voice, image, text and combinations thereof.

22. The emergency call processing method according to claim 20, wherein each emergency data call further carries location information or personal information for the caller.

23. The emergency call processing method according to claim 17, further comprising sending a confirmation message to the UE upon receipt of the emergency data call.

24. The emergency call processing method according to claim 23, wherein the confirmation message comprises registration identification.

25. The emergency call processing method according to claim 24, further comprising the UE switching to automatic hand-shaking mode after receiving a confirmation message.

26. The emergency call processing method according to claim 25, further comprising soliciting relevant information in an alert message to the UE.

27. The emergency call processing method according to claim 26, wherein the alert message is sent through a short message system (SMS).

28. The emergency call processing method according to claim 26, further comprising upon receipt of the alert message, the UE returns requested information in an automatic way.

29. The emergency call processing method according to claim 28, wherein the UE attaches registration identification to the relevant information for return.

30. The emergency call processing method according to claim 28, further comprising periodically communicating with the UE using an interleaving approach.

31. The emergency call processing method according to claim 26, wherein relevant information comprises location, caller's physical condition, current surrounding images, or combinations thereof.
